(19) United States
(12) Patent Application Publication
(10) Pub. No.: US 2022/0086224 A1
(43) Pub. Date: Mar. 17, 2022

(54) SYSTEM AND METHOD FOR OBTAINING DATA THROUGH SELECTING MIRROR SERVER ACCORDING TO IDENTIFICATION DATA

(71) Applicants: Inventec (Pudong) Technology Corporation, Shanghai (CN); INVENTEC CORPORATION, Taipei (TW)

(72) Inventor: Lan LUO, Shanghai (CN)

(73) Assignees: Inventec (Pudong) Technology Corporation, Shanghai (CN); INVENTEC CORPORATION, Taipei (TW)

(21) Appl. No.: 17/229,872

(22) Filed: Apr. 14, 2021

(30) Foreign Application Priority Data
Sep. 15, 2020 (CN) 2020109662703

(51) Int. Cl. H04L 29/08; H04L 29/06

(52) U.S. Cl. CPC H04L 67/1095; H04L 67/40; H04L 67/1053; H04L 67/1078

(57) ABSTRACT

The present disclosure discloses a system and method for obtaining data through selecting a mirror server according to identification data. By a technical means that after a master server selects a corresponding mirror server for a consumption host, when the master server detects that target data changes, the master server transmits an event notification message to the mirror server, and the mirror server transmits a download notification message to the consumption host, so that the consumption host downloads the target data from the mirror server, the load and complexity of a network management department to maintain access permissions of cross-domain access to servers can be reduced, and the technical effect of increasing the speed of downloading the target data by the consumption host is achieved.

### CROSS REFERENCE TO RELATED APPLICATION

The present application claims the benefit of priority to Chinese Patent Application No. 2020109662703, entitled “System and Method for Obtaining Data through Selecting Mirror Server According to Identification Data”, filed with CNIPA on Sep. 15, 2020, the content of which is incorporated herein by reference in its entirety.

### FIELD OF THE INVENTION

The present disclosure relates to a system for obtaining data and a method thereof, in particular, to a system and method for obtaining data through selecting a mirror server according to identification data.

### BACKGROUND

With the development of economy and technology, the scale of large-scale enterprises is getting bigger, and communication and transportation tools have also made great progress, so that enterprise groups may set up offices in different locations and establish internal networks to connect different offices.

An internal network established by an enterprise group usually establishes different domains based on different geographic locations, and sets satisfactory access permissions for each domain. In this way, hosts in different domains can be connected to specific servers for data access through a network topology and the access permissions of the domains.

Under such an architecture, data access in the same domain is usually unlimited and fast, but cross-domain data access may have slow transmission or unstable connection problems. As a result, when data of an enterprise is stored on servers of different domains, troubles are possibly caused. In addition, because access to different domains requires access permissions, the network management department needs to set corresponding access permissions for each host that needs to access the server, which will increase the workload of a network management department and the complexity of maintenance of the access permissions.

In summary, it can be seen that in the prior art, there has been a problem for a long time that cross-domain access to servers located in different geographical regions may increase the workload of the network management department and the complexity of maintenance. Therefore, it is necessary to propose improved technical means to solve this problem.

### SUMMARY

The present disclosure provides a system for obtaining data through selecting a mirror server according to identification data. The system includes: a consumption host, configured to set target identification data and configured to generate a registration request, wherein the registration request includes the target identification data; a plurality of mirror servers; and a master server, configured to receive the registration request and configured to select one of the mirror servers. The master server generates an event notification message when detecting that target data corresponding to the target identification data changes, and transmits the event notification message to the selected mirror server, so that the selected mirror server generates a download notification message and transmits the download notification message to the consumption host, thereby allowing the consumption host to be connected to the selected mirror server according to the download notification message to download the target data.

The present disclosure further provides a method for obtaining data through selecting a mirror server according to identification data. The method at least includes the following operations: setting, by a consumption host, target identification data; generating, by the consumption host, a registration request, and transmitting the registration request to a master server, wherein the registration request includes the target identification data; selecting, by the master server, a mirror server for the consumption host; when the master server detects that target data corresponding to the target identification data changes, generating an event notification message, and transmitting the event notification message to the mirror server; generating, by the mirror server, a download notification message and transmitting the download notification message to the consumption host; and connecting the consumption host to the mirror server according to the download notification message to download the target data.

The system and the method disclosed in the present disclosure are described above, and differ from the prior art in that in the present disclosure, after the master server selects the corresponding mirror server for the consumption host, when the master server detects that the target data changes, the master server transmits the event notification message to the mirror server, and the mirror server generates the download notification message after receiving the event notification message, and transmits the download notification message to the consumption host, so that the consumption host downloads the target data from the mirror server. Therefore, the problem in the prior art is solved, and the technical effect of increasing the speed of downloading the target data by the consumption host can be achieved.

### BRIEF DESCRIPTION OF THE DRAWINGS

FIG. 1 shows an architecture diagram of a system for obtaining data through selecting a mirror server according to identification data, provided in the present disclosure.

FIG. 2A shows a flow diagram of a method for obtaining data through selecting a mirror server according to identification data, provided in the present disclosure.

FIG. 2B shows an additional flow diagram of the method for obtaining data through selecting a mirror server according to identification data, provided in the present disclosure.

### REFERENCE NUMERALS ARE AS FOLLOWS

110: Consumption host

120: Master server

130: Mirror server

130a: Mirror server

140: Management server

Operation 210: A consumption host sets target identification data

Operation 220: The consumption host generates a registration request, and transmits the registration request to a master server

Operation 230: The master server selects a mirror server for the consumption host

Operation 251: The master server determines whether the consumption host and the mirror server are in the same domain

Operation 253: The master server generates a setting message, and transmits the setting message to a management server

Operation 255: The management server sets a communication permission between the consumption host and the mirror server according to the setting message

Operation 260: The master server detects whether target data corresponding to the target identification data changes

Operation 271: The master server generates an event notification message, and transmits the event notification message to the mirror server

Operation 275: The mirror server generates a download notification message, and transmits the download notification message to the consumption host

Operation 280: The consumption host is connected to the mirror server according to the download notification message, and downloads the target data

### DETAILED DESCRIPTION OF THE SPECIFIC EMBODIMENTS

The features and embodiments of the present disclosure will be described in detail below in conjunction with the drawings and embodiments. The content is sufficient to enable any of those ordinarily skilled in the art to easily and fully understand the technical means used by the present disclosure to solve the technical problems and implement them accordingly, so as to achieve the effects achievable by the present disclosure.

The present disclosure may set mirror servers of a master server in different domains, so that a consumption host in each domain can obtain target data maintained on the master server by the mirror server in the same domain. In the present disclosure, the target data obtained by the consumption host is usually related to a service offered by the consumption host. For example, if the consumption host offers the service of providing delivery information, the target data may be information related to an order, a product, or a client, and the like, but the present disclosure is not limited to this.

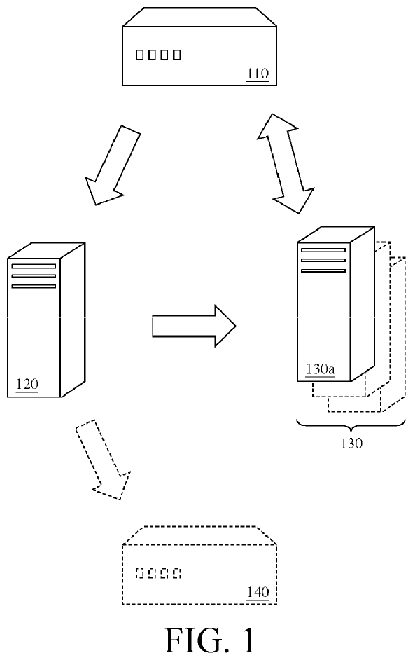

The system operation of the present disclosure is described below by an architecture diagram of a system for obtaining data through selecting a mirror server according to identification data in FIG. 1 of the present disclosure. Referring to FIG. 1, the system of the present disclosure includes a consumption host 110, a master server 120, a mirror server 130, and an additional management server 140. The consumption host 110, the master server 120, the mirror server 130, and the additional management server 140 may all be computing devices. It should be noted that in the present disclosure, there may be more than one consumption hosts 110 and mirror servers 130. That is, there may be two or more consumption hosts 110 or mirror servers 130.

The consumption host 110 may be connected with the master server 120 and the mirror server 130 through a wired network or a wireless network, and may receive data or signals transmitted by the master server 120 and/or the mirror server 130, or may transmit data or signals to the master server 120 and/or the mirror server 130.

The consumption host 110 may set one or more target identification data. The target identification data set by the consumption host 110 at least can express target data that the consumption host 110 intends to obtain. For example, the target identification data may be the name of the target data, and may also be the name of the target data and an operation identifier of an operation on the target data, and the like, but the present disclosure is not limited to this. The operation is to add, update, and delete the target data, and the like, but the operation is not limited to the above. Any action that can change the target data may be the operation provided in the present disclosure.

The consumption host 110 may generate a registration request. The registration request generated by the consumption host 110 includes the set target identification data. Generally, the registration request also includes network identification data of the consumption host 110. In some embodiments, the registration request may also include other messages, such as related information of the consumption host, and a request resource of the target data, but the present disclosure is not limited to this. The network identification data includes, but is not limited to, a network address (IP address).

The consumption host 110 may transmit the generated registration request to the master server 120. In most embodiments, the consumption host 110 may be connected with the master server 120 by using an application programming interface (API) provided by the master server 120, and transmit the registration request to the master server 120 through the API provided by the master server 120.

The consumption host 110 may receive a download notification message transmitted by a specific mirror server 130a. The download notification message received by the consumption host 110 may include the target identification data, and/or an API provided by the mirror server.

The consumption host 110 may be connected to the mirror server 130a that sends the download notification message according to the received download notification message, and may download the target data through the connected mirror server 130a. The consumption host 110 may be connected to the mirror server 130a according to an API recorded in the download notification message to download the target data, but the present disclosure is not limited to this. For example, the consumption host 110 may also directly transmit a request for downloading the target data back to the mirror server 130a when receiving the download notification message.

The master server 120 may be connected to the consumption host 110, the mirror server 130 and the management server 140 through a wired network or a wireless network, and may receive data or signals transmitted by the consumption host 110 and/or the mirror server 130 and/or the management server 140, and may also transmit data or signals to the consumption host 110 and/or the mirror server 130 and/or the management server 140.

The master server 120 may receive the registration request transmitted by the consumption host 110, and may select, after receiving the registration request, a specific mirror server 130a (in the present disclosure, the selected mirror server 130a is possibly represented by the mirror server 130a corresponding to the consumption host 110 or a description of the same meaning) from all the mirror servers 130 for the consumption host 110 that transmits the registration request. For example, the master server 120 may obtain the network identification data of the consumption host 110 from the registration request, and may select the mirror server 130a corresponding to the consumption host 110 from a plurality of mirror servers 130 according to the network identification data of the consumption host 110. In more details, when the network identification data is a network address, the master server 120 may select a mirror server 130a that is in the same domain as the consumption domain 110 according to the network address of the consumption host 110, that is, a mirror server 130a having the same network number as the consumption host 110 is selected. If the master server 120 determines that no mirror server exists in the domain where the consumption host 110 is located, the master server 120 may select a mirror server 130a that is in the same network segment as the consumption host 110. If there are a plurality of mirror servers 130 in the same network segment as the consumption host 110, the master server 120 may use a specific rule to select one of the mirror servers as the mirror server 130a corresponding to the consumption host 110. For example, the mirror server 130a is a mirror server that is randomly selected, or a mirror server, of which the numerical value expressed by the network address is closest to the numerical value expressed by the network address of the consumption host 110, but the present disclosure is not limited to this.

The master server 120 may also determine whether the consumption host 110 and the selected mirror server 130a are in the same domain, may generate a setting message when the consumption host 110 and the selected mirror server 130a are not in the same domain, and may transmit the generated setting message to the management server 140. In general, the setting message may include network addresses of the consumption host 110 and the selected mirror server 130a, and a port number, such as 80 and 443, of a communication port between the consumption host 110 and the mirror server 130a.

The master server 120 may also read the target identification data, and the network identification data of the consumption host 110 from the received registration request, and transmit the read target identification data and network identification data to the selected mirror server 130a.

The master server 120 may also store various types of data including the target data. If the master server 120 uses a database to store data, the master server 120 may additionally build and maintain a specific event table in the database, and may add a record that the data is operated into the maintained event table when the stored data is operated (such as added, modified, and deleted). The record stored in the event table may include the name of the data being operated and an operation identifier representing a behavior of operation, but the present disclosure is not limited to this.

The master server 120 may detect whether the target data corresponding to the received target identification data changes. If the master server 120 uses a database to store data, in some embodiments, the master server 120 may detect, through the maintained event table, whether the target data changes. In more details, the master server 120 may continuously monitor the record newly added into the event table or inquire the record newly added into the event table at regular intervals through a monitoring function provided by a database management program (or a database management system (DBMS)) to obtain the record newly added into the event table, and may determine that the target data changes when the obtained record includes the entire target identification data corresponding to the target data. For example, if the target identification data only records the name of the target data, when the record newly added into the event table includes the name of the target data, the master server 120 may determine that the target data changes; and if the target identification data includes the name of the target data and the operation identifier, the master server 120 may determine that the target data changes only when the record newly added into the event table includes both the name of the target data and the same operation identifier.

The master server 120 may generate an event notification message when detecting that the target data corresponding to the received target identification data changes, and may transmit the generated event notification message to the mirror server 130a corresponding to the consumption host 110. The event notification message generated by the master server 120 includes the target identification data corresponding to the changed target data. In some embodiments, the event notification message may further include the network identification data of the consumption host 110 and/or the changed target data.

The mirror server 130 may be connected to the master server 120 and the consumption host 110 through a wired network or a wireless network, and may receive data or signals transmitted by the master server 120 and/or the consumption host 110, or may transmit data or signals to the master server 120 and/or the consumption host 110.

The mirror server 130 may synchronize data with the master server 120. The data synchronized between the mirror server 130 and the master server 120 may be all the data stored in the master server 120 or the target data corresponding to the target identification data transmitted by the corresponding consumption host 110 to the master server 120.

The mirror server 130 may receive the event notification message transmitted by the master server 120. The mirror server 130 may also receive the target identification data transmitted by the master server 120 and the network identification data of the consumption host 110, and may record the received target identification data, and the received network identification data of the consumption host 110.

The mirror server 130 may generate a download notification message when receiving the event notification message, and transmit the generated download notification message to the corresponding consumption host 110. If the event notification message includes the network identification data of the consumption host 110, the mirror server 130 may selectively transmit the target identification data included in the event notification message to the consumption host 110 according to the network identification data in the event notification message; and if the mirror server 130 records the target identification data, and the network identification data of the consumption host 110, the mirror server 130 may selectively read the network identification data corresponding to the target identification data in the event notification message, and transmit the target identification data included in the event notification message to the corresponding consumption host 110 according to the read network identification data. However, if the event notification message includes the network identification data of the consumption network 110, and the mirror server 130 records the target identification data, and the network identification data of the consumption host 110, the mirror server 130 may select one of the above two modes for transmitting the target identification data to the consumption host 110.

The mirror server 130 may receive a read request transmitted by the corresponding consumption host 110, read the corresponding target data according to the target identification data in the received read request, and transmit the read target data back to the corresponding consumption host 110. In some embodiments, the mirror server 130 may provide an API to the consumption host 110, receive the read request transmitted by the consumption host 110 through the provided API, and transmit the target data back to the consumption host 110 through the API.

The management server 140 may be connected to the master server 120 through a wired network or a wireless network, may receive data or signals transmitted by the master server 120, and may transmit data or signals to the master server 120.

The management server 140 may receive the setting message generated by the master server 120, and may set a communication permission between the consumption host 110 and the corresponding mirror server 130a according to the received setting message. For example, it is set that the consumption host 110 and the corresponding mirror server 130a may use specific communication ports to transmit data or signals to each other.

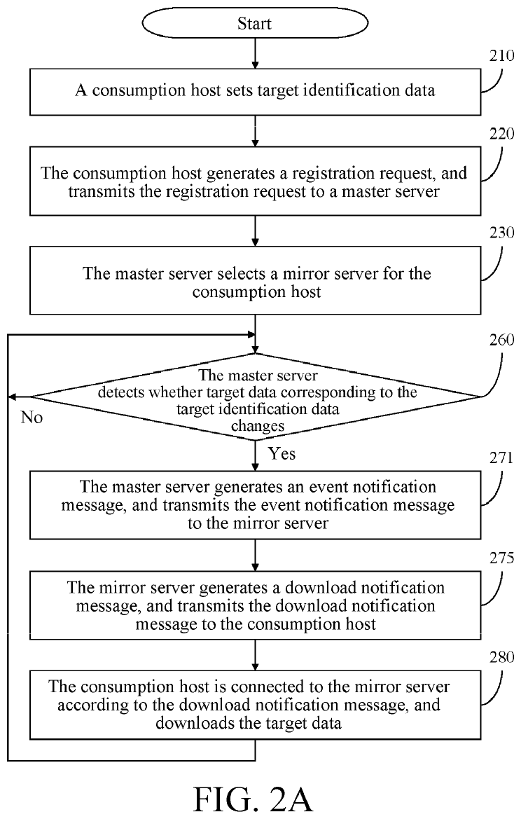

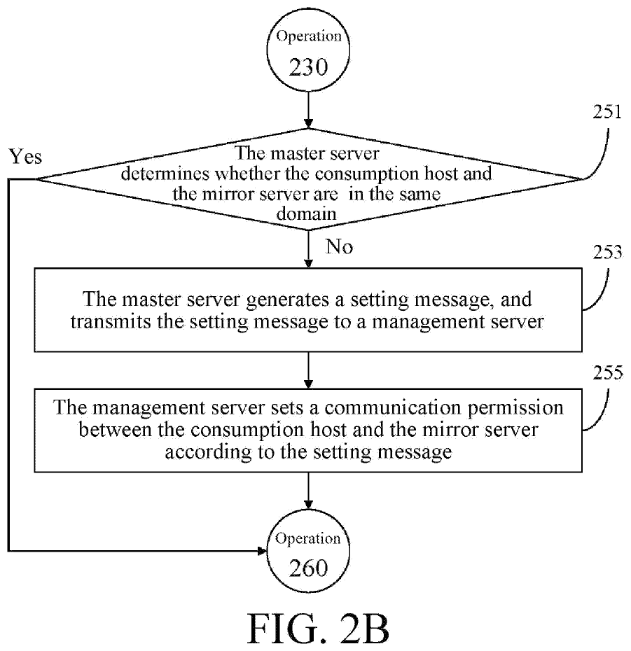

FIG. 2A illustrates a flow diagram of a method for obtaining data through selecting a mirror server according to identification data, and an operation system and method is described according to an embodiment of the present disclosure.

Firstly, the consumption host 110 may set target identification data corresponding to target data needing to be followed (Operation 210). In the present embodiment, it is assumed that the target identification data is the name of the target data.

Then, the consumption host 110 may generate a registration request, and may transmit the generated registration request to the master server 120 (Operation 220). In the present embodiment, it is assumed that the registration request further includes apparatus identification data of the consumption host 110 and an access site of the target identification data in addition to the target identification data. The consumption host 110 may transmit the registration request to the master server 120 according to an API provided by the master server 120.

After the master server 120 receives the registration request transmitted by the consumption host 110, the master server 120 may select a mirror server serving as the mirror server 130a corresponding to the consumption host 110 for the consumption host 110 that sends the registration request (Operation 230). In the present embodiment, it is assumed that the master server 120 may obtain a network address of the consumption host 110 from the registration request, and selects a slave server, which is in the same domain as the consumption host 110, from all the mirror servers 130 as the mirror server 130a corresponding to the consumption host 110 according to the obtained network address.

Similarly, after the master server 120 receives the registration request transmitted by the consumption host 110, the master server 120 may detect whether the target data corresponding to the received target identification data changes (Operation 260). In the present embodiment, it is assumed that the master server 120 uses a database to store data. If the master server 120 builds and maintains an event table for operating the stored data, the master server 120 may inquire a record newly added into the event table at regular intervals or continuously monitor the record newly added into the event table through a monitoring function of the database, and determine that the target data changes when the record newly added into the event table includes the target identification data.

After the master server 120 detects that the target data corresponding to the received target identification data changes, the master server 120 may generate an event notification message, and may transmit the generated event notification message to the mirror server 130a (Operation 271). In the present embodiment, it is assumed that the event notification message generated by the master server 120 includes the target identification data corresponding to the changed target data and the network identification data of the consumption host 110 that has transmitted the target identification data, and then the master server 120 may transmit the event notification message to the consumption host 110 corresponding to the network identification data included in the event notification message.

After the mirror server 130 receives the event notification message transmitted by the master server 120, the mirror server 130a may generate a download notification message, and may transmit the generated download notification message to the corresponding consumption host 110 (Operation 275). In the present embodiment, it is assumed that the download notification message generated by the mirror server 130a includes the target identification data and the provided API that reads the target data, and then the mirror server 130a may transmit the download notification message to the corresponding consumption host 110 according to the network identification data in the event notification message.

Practically, after the master server 120 selects the mirror server 130a for the consumption host 110 that sends the registration request (Operation 230), the master server 120 may further transmit the target identification data in the registration request and the network identification data of the consumption host 110 to the selected mirror server 130a. After the mirror server 130a receives the target identification data and the network address of the consumption host 110 transmitted by the master server 120, the mirror server 130a may record the received target identification data, and the received network identification data of the corresponding consumption host 110. In this way, when the master server 120 generates the event notification message, the master server 120 may only generate the target identification data corresponding to the changed target data, and may transmit the generated event notification message to the mirror server 130a corresponding to the consumption host 110 that has transmitted the target identification data (Operation 271). After receiving the event notification message, the mirror server 130a may generate the download notification message that includes the target identification data in the event notification message and the provided API, and may read the corresponding network identification data according to the received target identification data and transmit the generated download notification message to the consumption host 110 corresponding to the read network identification data (Operation 275).

After the consumption host 110 receives the notification message transmitted by the corresponding mirror server 130a, the consumption host 110 may be connected to the mirror server 130a according to the notification message, and downloads the target data from the mirror server 130a (Operation 280). In the present embodiment, it is assumed that the consumption host 110 may be connected to the mirror server 130a according to the API included in the notification message, and makes a request to download the target data from the mirror server 130a.

In this way, through the present disclosure, an optimal mirror server 130a may be automatically selected for the consumption host 110 in a multi-domain and multi-mirror-site network environment.

In the above embodiments, after the master server 120 selects the corresponding mirror server 130a for the consumption host 110 (Operation 230), as shown in the flowchart of FIG. 2B, the master server 120 may determine whether the selected mirror server 130a and the consumption host 110 are in the same domain (Operation 251). If not, the master server 120 may generate a setting message, and transmit the generated setting message to the management server 140 (Operation 253).

After receiving the setting message, the management server 140 may set a communication permission between the consumption host 110 and the corresponding mirror server 130a according to the received setting message (Operation 255), so that the mirror server 130a may transmit the download notification message to the corresponding consumption host 110, and the consumption host 110 may also be connected to the corresponding mirror server 130a according to the download notification message to download the target data (Operations 260 to 280).

In summary, it can be seen that the present disclosure differ from the prior art in having a technical means that after the master server selects the corresponding mirror server for the consumption host, when the master server detects that the target data changes, the master server transmits the event notification message to the mirror server, and the mirror server transmits the download notification message to the consumption host, so that the consumption host downloads the target data from the mirror server. This technical means can solve the problem that cross-domain access to servers located in different geographical regions may increase the load of the network management department and the complexity of maintenance. Therefore, the technical effect of increasing the speed of downloading the target data by the consumption host is achieved.

In addition, the method for obtaining data through selecting a mirror server according to identification data of the present disclosure may be implemented in different hardware, software, or a combination of computer systems of hardware and software.

Although the disclosed implementations of the present disclosure are described as above, the content described is not intended to directly limit the scope of patent protection of the present disclosure. Several modifications, which are made by any person with ordinary knowledge in the art of the present disclosure without departing from the spirit and scope disclosed by the present disclosure, to the form and details of the implementations of the present disclosure shall all fall within the scope of patent protection of the present disclosure. The scope of patent protection of the present disclosure shall still be subject to those defined by the attached patent application scope.

What is claimed is:

1. A method for obtaining data through selecting a mirror server according to identification data, at least comprising the following operations:
setting, by a consumption host, target identification data;
generating, by the consumption host, a registration request, and transmitting the registration request to a master server, wherein the registration request comprises the target identification data;
selecting, by the master server, a mirror server for the consumption host;
when the master server detects that target data corresponding to the target identification data changes, generating an event notification message, and transmitting the event notification message to the mirror server;
after receiving the event notification message, generating, by the mirror server, a download notification message, and transmitting the download notification message to the consumption host; and
connecting the consumption host to the mirror server according to the download notification message to download the target data.

2. The method for obtaining data through selecting a mirror server according to identification data as in claim 1, wherein the operation of selecting, by the master server, the mirror server for the consumption host comprises: selecting, by the master server, the mirror server according to network identification data of the consumption host.

3. The method for obtaining data through selecting a mirror server according to identification data as in claim 1, wherein the operation of detecting, by the master server, that the target data corresponding to the target identification data changes comprises: continuously monitoring, by the master server, an event table or inquiring the event table at regular intervals, and determining that the target data changes when the event table records an event that the target data is operated.

4. The method for obtaining data through selecting a mirror server according to identification data as in claim 1, wherein the operation of connecting the consumption host to the mirror server according to the download notification message comprises: connecting the consumption host to the mirror server according to an application programming interface recorded in the download notification message.

5. The method for obtaining data through selecting a mirror server according to identification data as in claim 1, wherein after the operation of selecting, by the master server, the mirror server for the consumption host, the method further comprises: generating a setting message when the master server determines that the consumption host and the mirror server are not in the same domain, and transmitting the setting message to a management server, so that the management server sets a communication permission between the consumption host and the mirror server according to the setting message.

6. A system for obtaining data through selecting a mirror server according to identification data, at least comprising:
a consumption host, configured to set target identification data and configured to generate a registration request, wherein the registration request comprises the target identification data;
a plurality of mirror servers; and
a master server, configured to receive the registration request and select one of the plurality of mirror servers, and configured to generate an event notification message when detecting that target data corresponding to the target identification data changes, and transmit the event notification message to the selected mirror server, so that the mirror server generates a download notification message and transmits the download notification message to the consumption host, thereby allowing the consumption host to be connected to the selected mirror server according to the download notification message to download the target data.

7. The system for obtaining data through selecting a mirror server according to identification data as in claim 6, wherein the master server selects one of the plurality of mirror servers according to network identification data of the consumption host.

8. The system for obtaining data through selecting a mirror server according to identification data as in claim 6, wherein the master server continuously monitors an event table or inquires the event table at regular intervals, and determines that the target data changes when the event table records an event that the target data is operated.

9. The system for obtaining data through selecting a mirror server according to identification data as in claim 6, wherein the consumption host is connected to the mirror server according to an application programming interface recorded in the download notification message.

10. The system for obtaining data through selecting a mirror server according to identification data as in claim 6, further comprising: a management server configured to receive a setting message generated when the master server determines that the consumption host and the selected mirror server are not in the same domain, and set a communication permission between the consumption host and the selected mirror server according to the setting message.
